(19) United States
(12) Patent Application Publication
(10) Pub. No.: US 2025/0178377 A1
(43) Pub. Date: Jun. 5, 2025

(54) BULKHEAD FOR HEAVY-DUTY VEHICLE AXLES

(71) Applicant: Hendrickson USA, L.L.C., Schaumburg, IL (US)

(72) Inventors: Jeff R. Zawacki, Channahon, IL (US); Donald R. Hester, East Canton, OH (US); William W. Brewer, Atwater, OH (US); Francisco J. Arevalo, Rochester Hills, MI (US); Alison R. Waugh, Massillon, OH (US); Andrew M. Crow, Uniontown, OH (US); Donald J. Dagnall, JR., Norton, OH (US)

(21) Appl. No.: 18/956,438

(22) Filed: Nov. 22, 2024

Related U.S. Application Data
(60) Provisional application No. 63/604,974, filed on Dec. 1, 2023.

(51) Int. Cl. B60B 35/04

(52) U.S. Cl. CPC B60B 35/04; B60B 2900/5112; B60B 2900/5114

(57) ABSTRACT

An axle for a heavy-duty vehicle comprising a central tube, a pair of spindles, and a bulkhead. Each spindle of the pair of spindles is disposed at a respective axial end of the central tube. The bulkhead is disposed at least partially within an opening formed into the central tube and attached to the axle, providing support and connection for conduits passing from outside of the axle into the central tube while preventing ingress of water, contaminants, and debris into the central tube.

### CROSS-REFERENCE TO RELATED APPLICATION

This application claims the benefit of U.S. Provisional Patent No. 63/604,974, filed Dec. 1, 2023.

### BACKGROUND

### Technical Field

The disclosed subject matter relates generally to axles for heavy-duty vehicles. In particular, the disclosed subject matter relates to heavy-duty vehicles that utilize relatively thin-walled axles. More particularly, the disclosed subject matter relates to a reinforced bulkhead for large openings in heavy-duty vehicle thin-walled axles that provides support and/or connection for multiple conduits, tubing, and/or cables passing between the interior and exterior of the axle while also preventing ingress of water, contaminants, and/or debris into the axle as well as maintaining the strength and service-life of the axle and allowing the conduits, tubing, and/or cables to be easily and efficiently routed into and through the axle.

### Background Art

Heavy-duty vehicles typically include multiple axles that are longitudinally spaced apart along the heavy-duty vehicle to accommodate the weight of cargo and create ride stability, as is known. For the purposes of clarity and convenience, reference is made to a heavy-duty vehicle with the understanding that such reference includes trucks, tractor-trailers or semi-trailers, trailers, and the like.

Prior art axles of heavy-duty vehicles typically include a central tube having axially-opposite ends. An outboardly-extending spindle is mounted on respective axial ends of each central tube. A wheel end assembly with one or more wheels is rotatably mounted on each of the spindles, as is known. A pair of suspension assemblies connects each prior art axle to members of the frame or subframe of the heavy-duty vehicle. For those heavy-duty vehicles that support a subframe, the subframe can be non-movable or movable, the latter being commonly referred to as a slider box, slider subframe, slider undercarriage, secondary slider frame, or bogey. The combination of the suspension assemblies and prior art axle is generally referred to in the art as an axle/suspension system. For the purposes of clarity and convenience, reference is made to axles with the understanding that such axles are used in heavy-duty vehicle axle/suspension systems.

Prior art axles for heavy-duty vehicles are generally heavy because the central tube typically has a wall thickness in the range of about 0.500 inches to about 0.750 inches. However, federal weight and stress regulations, such as Federal Bridge Gross Weight Formula, typically limit the overall weight of heavy-duty vehicles. As a result, heavy-duty vehicles utilizing prior art axles may be limited in the amount of cargo that can be legally carried. More recently, heavy-duty vehicles have utilized prior art axles with thinner walls in order to reduce the weight of the axle/suspension system and increase the amount of cargo that may be carried. Such prior art thin-walled axles have central tubes with a wall thickness in the range from about 0.301 inches to about 0.400 inches, but may also be in the range from about 0.225 inches to about 0.300 inches.

As the heavy-duty vehicle is traveling over the road, the wheels encounter road conditions that impart various forces, loads, and/or stresses, collectively referred to herein as forces, to the axle on which the wheels are mounted. Such forces include vertical forces caused by vertical movement of the wheels as they encounter certain road conditions, fore-aft forces and torques caused by acceleration and deceleration of the heavy-duty vehicle and certain road conditions, and side-load and torsional forces associated with heavy-duty vehicle transverse movement, such as turning and lane-change maneuvers. Thus, prior art axles must be designed to be durable and capable of withstanding the forces applied and resisting fatigue from the forces applied during operation.

Prior art axles, while adequate for the intended purpose, have potential disadvantages, drawbacks, and limitations. For example, some heavy-duty vehicles utilizing prior art axles, in order to maintain a target fluid pressure within the tire of each wheel, also utilize tire inflation systems. These tire inflation systems typically monitor and attempt to maintain the fluid pressure within each tire at or near the target pressure by inflating and/or deflating the tire when the pressure drops below or exceeds the target pressure. More specifically, tire inflation systems provide fluid from a source of fluid pressure to the tires through a supply conduit disposed within the central tube of the prior art axle to a rotary union mounted on the end of the axle spindle or a hubcap of the wheel, as is known. Because the supply conduit is disposed within the central tube in order to connect to the rotary union, the prior art axle must have an opening to allow the conduit to pass into the central tube, potentially weakening the structure of the prior art axle as well as potentially allowing ingress of water, contaminants, and/or debris, which may potentially cause corrosion and/or contamination of the wheel end assembly lubrication, thereby reducing the service-life of the prior art axles and wheel end assemblies. Moreover, the supply conduit and/or rotary union may potentially experience a leak or rupture, allowing air pressure to build up within the prior art axle and wheel end assembly. As a result, components of the wheel end assembly may potentially be damaged and/or lubricant may be lost, thereby reducing the service-life of components of the wheel end assembly. Thus, prior art axles may also require additional openings for venting or exhausting such build-ups of fluid pressure, thereby potentially further weakening the structure and/or shortening the service-life of the prior art axles.

In addition, certain types of heavy-duty vehicles utilizing prior art axles, such as refrigerated trailers or reefers, also utilize large, fuel-driven equipment, such as compressors, to provide a temperature-controlled environment within the heavy-duty vehicle trailer. Recent technological advances and increased regulation of engines used to run fuel-driven equipment, such as compressors, have made electrically-powered equipment more advantageous. However, electrically-powered equipment may require transmission of electrical energy from sources of electrical energy, such as batteries, solar panels, axle- or wheel-mounted generators or harvesters, or the like, to the equipment. Sources of electrical energy may also require transmission or circulation of coolant to and from the sources of electrical energy. Such conduits, tubing, and/or cables are typically routed outside of prior art axles in areas that may encounter extremely high vibrations and are potentially unprotected from environmental hazards, such as extreme temperatures, while creating packaging challenges. In order to facilitate packaging and protect critical components of electrical energy generation and transmission, multiple large, insulated conduits, tubing, and/or cables may need to be routed through the central tube of the prior art axle to electrically connect axle- and wheel-mounted generators with electrical equipment and/or electrical storage. As a result, additional and/or relatively larger openings may need to be formed in the prior art axle to pass large conduits, tubing, and/or cables through, thereby potentially weakening and/or reducing the service-life of the prior art axles even further.

Thus, there is a need in the art for a bulkhead for large openings of heavy-duty vehicle thin-walled axles that provides support and/or connection for multiple conduits, tubing, and/or cables passing between the interior and exterior of the axle while also preventing ingress of water, contaminants, and/or debris into the axle, while maintaining the strength and service-life of the axle as well as allowing the conduits, tubing, and/or cables to be easily and efficiently routed into and through the axle.

### BRIEF SUMMARY OF THE INVENTION

Objectives of the subject disclosure include providing a bulkhead for large openings in heavy-duty vehicle thin-walled axles that supports and/or connects multiple conduits, tubing, and/or cables passing between the interior and exterior of the axle.

A further objective of the subject disclosure is to provide a bulkhead for large openings in heavy-duty vehicle thin-walled axles that easily and efficiently routes conduits, tubing, and/or cables into and through the axle.

Yet another objective of the subject disclosure is to provide a bulkhead for large openings in heavy-duty vehicle thin-walled axles that prevents the ingress of water, contaminants, and/or debris into the axle.

Still another objective of the subject disclosure is to provide a bulkhead for large openings in heavy-duty vehicle thin-walled axles that maintains the strength and service-life of the axle.

These objectives and advantages are obtained by the axle for a heavy-duty vehicle comprising a central tube, a pair of spindles, and a bulkhead. Each spindle of the pair of spindles is disposed at a respective axial end of the central tube. The bulkhead is disposed at least partially within an opening formed into the central tube and attached to the axle, providing support and connection for conduits passing from outside of the axle into the central tube.

### BRIEF DESCRIPTION OF THE SEVERAL VIEWS OF THE DRAWINGS

The preferred embodiments of the subject disclosure, illustrative of the best mode in which Applicant has contemplated applying the principles, are set forth in the following description, shown in the drawings, and particularly and distinctly pointed out and set forth in the appended claims.

FIG. 1 is a fragmentary elevational view, partially in section, of a heavy-duty vehicle axle/suspension system incorporating a prior art axle;

FIG. 2 is a fragmentary perspective view, partially in ghost, of a portion of a heavy-duty vehicle axle/suspension system incorporating a first exemplary embodiment bulkhead, according to the disclosed subject matter, showing the bulkhead without a cover plate or gasket, and showing conduits, tubing, and/or cables routed into and through the axle;

FIG. 3 is a fragmentary perspective view of a portion of the axle incorporating the first exemplary embodiment bulkhead shown in FIG. 2, showing the bulkhead with a cover plate without openings;

FIG. 4 is an exploded view of the first exemplary embodiment bulkhead shown in FIGS. 2-3;

FIG. 5 is a perspective view of a body of the first exemplary embodiment bulkhead shown in FIGS. 2-4;

FIG. 6 is a fragmentary view of an axle incorporating the first exemplary embodiment bulkhead of FIGS. 2-4, showing the bulkhead in exploded view, showing the cover plate incorporating a vent and compression fitting, and showing conduits, tubing, and/or cables routed into and through the axle;

FIG. 7 is a perspective view of the cover plate shown in FIG. 6, showing the cover plate with the vent removed;

FIG. 8 is an elevational view, in section, of the cover plate shown in FIGS. 6-7, showing the cover plate with the vent removed;

FIG. 9 is an exploded view of the first exemplary embodiment bulkhead shown in FIGS. 2-4, showing the cover plate incorporating a vent and an alternative compression fitting;

FIG. 10 is a perspective view of the cover plate shown in FIG. 9, showing the cover plate with the vent removed;

FIG. 11 is an elevational view, in section, of the cover plate shown in FIGS. 9-10, showing the cover plate with the vent removed;

FIG. 12 is a fragmentary elevational view of a portion of an axle incorporating a second exemplary embodiment bulkhead, according to the disclosed subject matter;

FIG. 13 is a perspective view of the second exemplary embodiment bulkhead shown in FIG. 12, showing the bulkhead with fittings removed;

FIG. 14 is a fragmentary elevational view of a portion of an axle incorporating an alternative configuration of the second exemplary embodiment bulkhead shown in FIGS. 12-13;

FIG. 15 is a perspective view of the alternative configuration of the second exemplary embodiment bulkhead shown in FIG. 14;

FIG. 16 is a fragmentary elevational view of a portion of an axle incorporating a third exemplary embodiment bulkhead, according to the disclosed subject matter;

FIG. 17 is a top perspective view of the third exemplary embodiment bulkhead shown in FIG. 16, showing the bulkhead with fittings removed;

FIG. 18 is a bottom perspective view of the third exemplary embodiment bulkhead shown in FIGS. 16-17;

FIG. 19 is a fragmentary elevational view of an axle incorporating a fourth exemplary embodiment bulkhead, according to the disclosed subject matter;

FIG. 20 is a fragmentary perspective view, in section, of the axle incorporating the fourth exemplary embodiment bulkhead shown in FIG. 19;

FIG. 21 is a perspective view of the fourth exemplary embodiment bulkhead shown in FIGS. 19-20;

FIG. 22 is a fragmentary perspective view, in section, of an axle incorporating a fifth exemplary embodiment bulkhead, according to the disclosed subject matter; and

FIG. 23 is an elevational view, in section, of the fifth exemplary embodiment bulkhead shown in FIG. 22.

Similar characters refer to similar parts throughout.

### DESCRIPTION OF THE PREFERRED EMBODIMENT

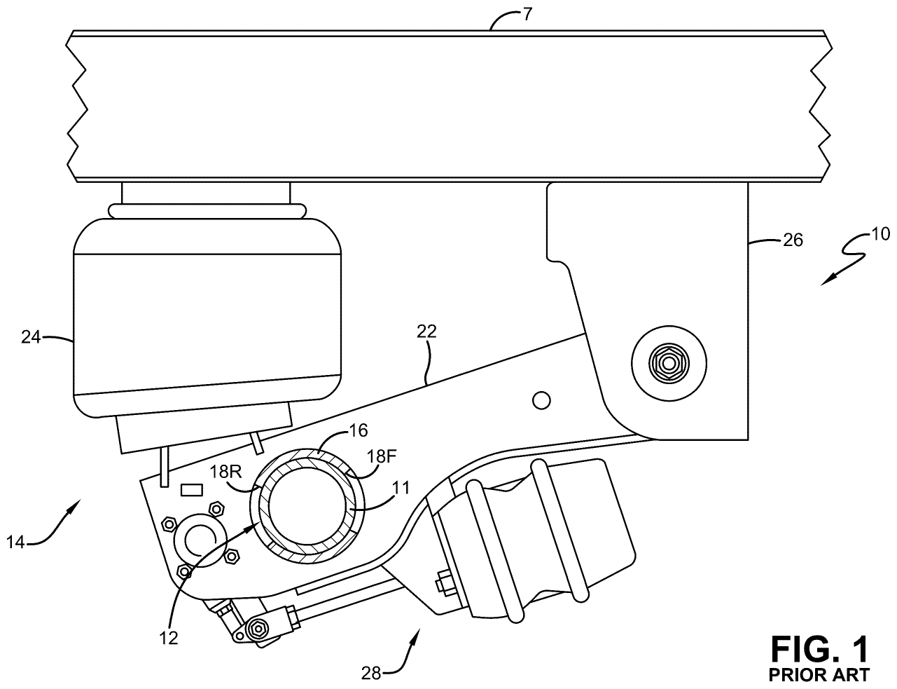

In order to better understand the disclosed subject matter, an axle/suspension system 10 (FIG. 1) incorporating a prior art axle 12 is shown mounted on a main member 7 of a heavy-duty vehicle (not shown). Axle/suspension system 10 generally includes a pair of mirror-image suspension assemblies 14 (only one shown). Because suspension assemblies 14 are mirror images, and for the sake of clarity, only one of the suspension assemblies is described.

Suspension assembly 14 is pivotally connected to a hanger 26 via a generally U-shaped beam 22. More specifically, beam 22 is pivotally connected at one longitudinal end to hanger 26. Prior art axle 12 includes a hollow central tube 11 transversely-extending from and welded or otherwise rigidly attached to beam 22 at the end of the beam opposite the pivotal connection. A sleeve 16 is disposed about prior art axle 12 between the axle and beam 22. Sleeve 16 includes a front window 18F formed in the sleeve adjacent the front portion of prior art axle 12. Similarly, a rear window 18R is formed in sleeve 16 adjacent the rear portion of prior art axle 12. Front and rear windows 18F, R are formed in sleeve 16 so that they are generally symmetrical in size and shape and angled with respect to the horizontal centerline of prior art axle 12. Both front and rear windows 18F, R are attached to prior art axle 12 by a continuous window weld (not shown) laid around the perimeter of the window, as is known. Suspension assembly 14 also includes an air spring 24 mounted on and extending between beam 22 and main member 7. A braking system 28 is also shown mounted to axle/suspension system 10.

Prior art axle 12, while adequate for the intended purpose, may have potential disadvantages, drawbacks, and limitations. For example, incorporating a tire inflation system and/or wheel-mounted electrical generators into prior art axle 12 may require one or more relatively large openings to be formed in the axle to allow for the attachment of an axle vent and/or to allow conduits, cables, tubing, or the like to pass into the central tube, potentially weakening the structure of the axle as well as potentially allowing ingress of water, contaminants, and/or debris, which may potentially cause corrosion, thereby reducing the strength and service-life of the prior art axle.

As a result, a need exists in the art for a bulkhead that provides large openings formed in heavy-duty vehicle thin-walled axles with support and connection for multiple conduits, tubing, and/or cables, referred to herein generally as conduits with the understanding that such reference includes conduits, tubing, cables, and the like, passing between the interior and exterior of the axle while also preventing ingress of water, contaminants, and/or debris into the axle, while maintaining the strength and service-life of the axle as well as allowing the conduits to be easily and efficiently routed into and through the axle.

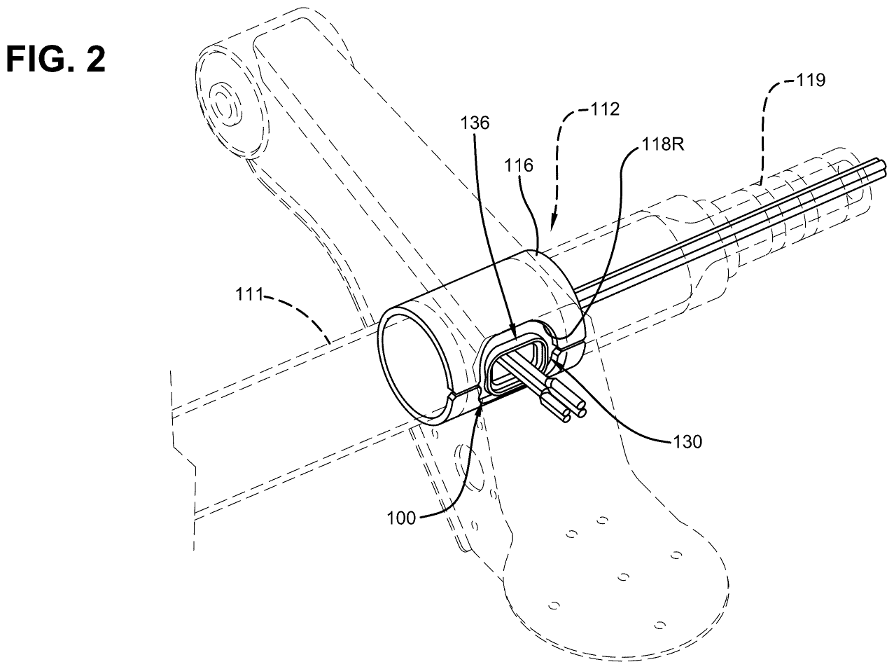

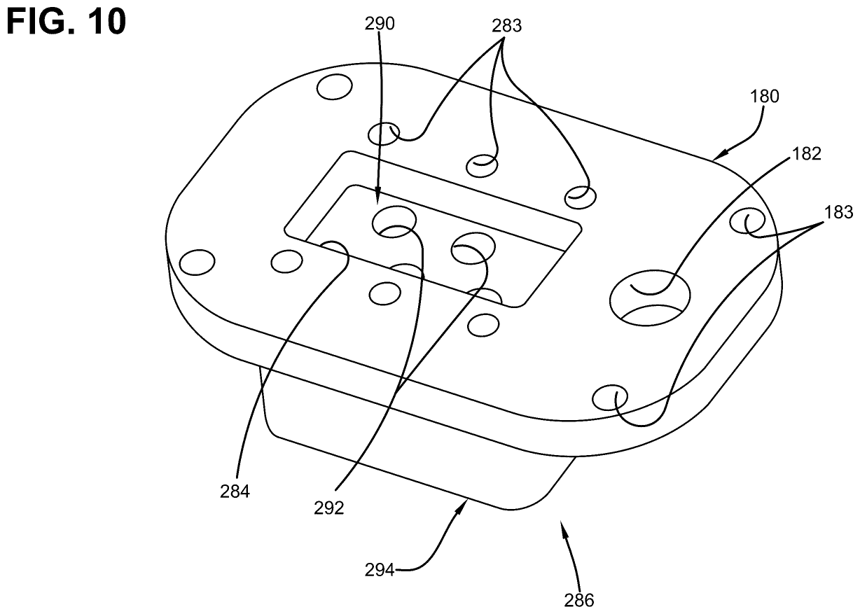

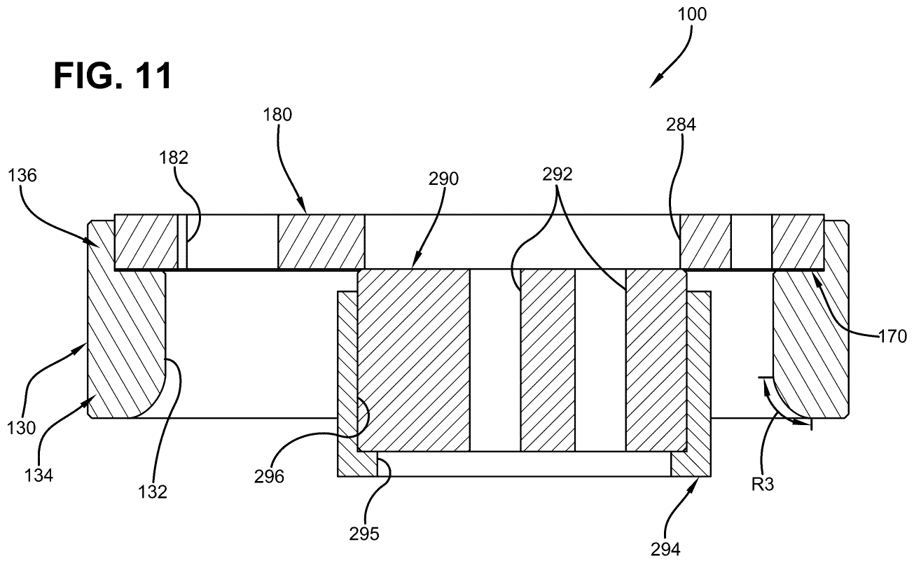

A first exemplary embodiment bulkhead 100 (FIGS. 2-11), according to the disclosed subject matter, may be incorporated into any suitable axle, such as an axle 112 (partially shown), of any suitable axle/suspension system, such as axle/suspension system 10, described above, and utilized with any suitable braking system, such as braking system 28, for a heavy-duty vehicle (not shown).

Axle 112 may be similar in structure and arrangement to prior art axle 12. In particular, axle 112 may be a standard axle having a diameter or dimension of about 5.0 inches with a central tube 111 (partially shown) having a wall thickness in the range of about 0.500 inches to about 0.750 inches. More preferably, axle 112 may be a large diameter, thin-walled axle typically having a diameter or dimension of about 5.75 inches with central tube 111 having a wall thickness in the range of about 0.301 inches to about 0.400 inches, more preferably in the range of from about 0.310 inches to about 0.380 inches. Axle 112 also includes a pair of spindles 119 (only one shown), each one of which is rigidly attached by any suitable method, such as welding, to axially opposite ends of central tube 111, as is known.

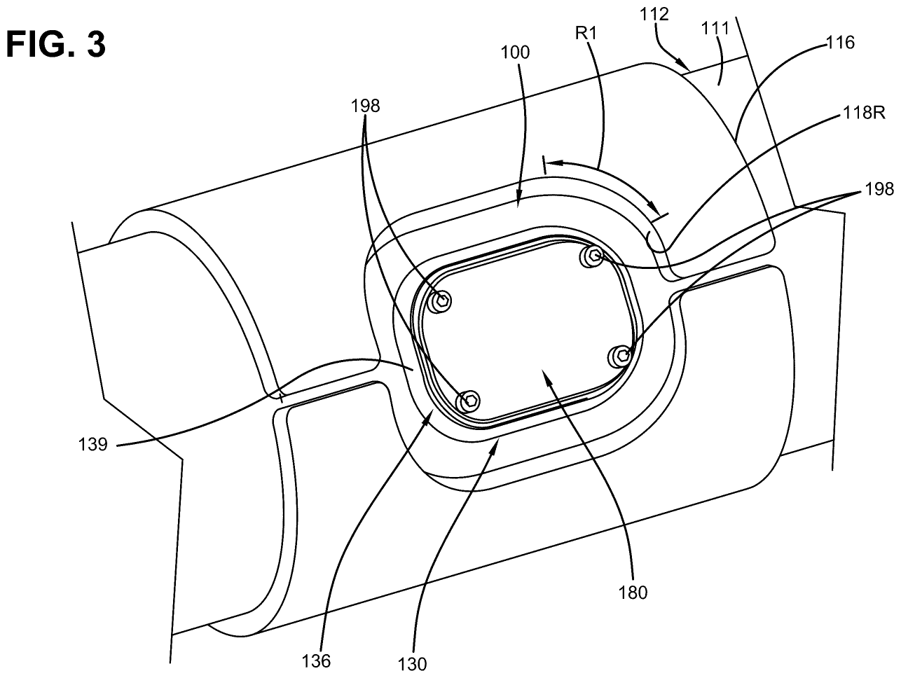

Axle 112 is surrounded by a pair of axially-spaced sleeves 116 (only one shown). Each sleeve 116 includes at least a rear window 118R formed through the sleeve adjacent the rear portion of axle 112. Each rear window 118R may be formed with any suitable shape, such as oblong, superelliptical, round, rectangular, or the like, and may include a radius curvature R1 (FIG. 3). Each rear window 118R is generally formed through the respective sleeve 116 such that the rear windows are symmetrically angled with respect to the horizontal centerline of axle 112, as is known. Sleeve 116 may be attached to axle 112 by a continuous weld (not shown) laid around the perimeter of rear window 118R in a well-known manner. Alternatively, it is contemplated that sleeve 116 may be disposed about and attached to axle 112 by any other suitable method, such as crimping or interference or press fit.

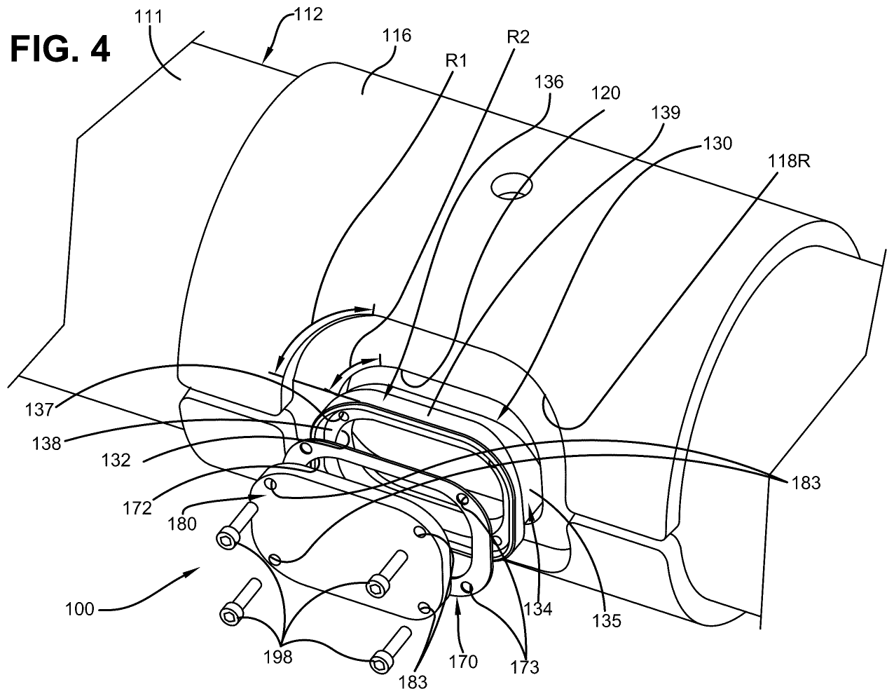

An opening 120 (only one shown) (FIG. 4) may be formed through the wall of central tube 111 of axle 112 and may have any suitable shape, such as oblong, superelliptical, round, rectangular, or the like. In particular, opening 120 may be formed and located within rear window 118R as a superellipse extending through the wall of axle 112 and may occupy a portion of the window in the range of from about 10% to about 83%, more preferably from about 50% to about 63%. More particularly, opening 120 may be located within and occupy a portion of rear window 118R such that the edges of the opening are up to about 0.5 inches from the toe of the continuous weld (not shown). It is also contemplated that, in the event that sleeve 116 is disposed about and attached to axle 112 by crimping, press fit or interference fit, or another suitable method, opening 120 may be located within and occupy a portion of rear window 118R up to 100% of the window. Opening 120 may include at least one radius curvature R2. Radius curvature R2 may have any suitable measurement such that a ratio of the radius curvature of opening 120 to radius curvature R1 of rear window 118R may be in the range of from about 1:0.81 to about 1:5, more preferably 1:1.61 to about 1:1.88.

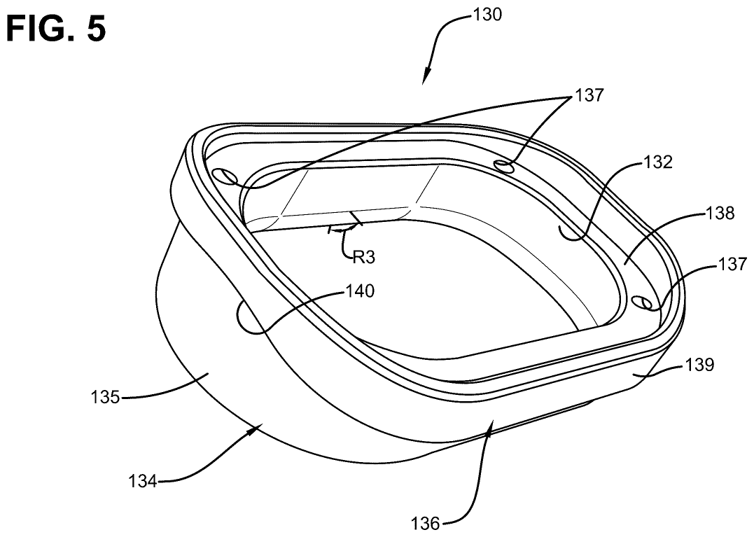

In accordance with an important aspect of the disclosed subject matter, first exemplary embodiment bulkhead 100 may be disposed within and/or partially through opening 120 of central tube 111. Bulkhead 100 includes a body 130, a seal or gasket 170, and an interface or cover plate 180. Body 130 is generally tubular having any suitable cross-sectional shape, such as rectangular or circular, and is formed with an axially central opening 132. Body 130 includes a lower portion 134 and an upper portion 136. Upper portion 136 may be formed with a frame or bezel 138 having an outer edge 139 that extends radially-outward from at least a portion of axial opening 132 and lower portion 134, forming a flange 140 (FIG. 5). It is also contemplated that outer edge 139 may be flared radially-outward from opening 132 of body 130 as the edge extends toward lower portion 134. Outer edge 139 may have any suitable height or dimension extending axially outward from flange 140, but generally corresponds to the outer dimensions of sleeve 116 and window 118R to facilitate assembly and installation of bulkhead 100 on axle 112. Bezel 138 may be formed as a recessed rim or area with a plurality of spaced-apart openings 137. Openings 137 may extend through at least a portion of bezel 138 into lower portion 134 of body 130.

Flange 140 and lower portion 134 of body 130 may have a profile or shape that generally corresponds to the outer surface of axle 112 to facilitate attachment of bulkhead 100 to the axle. More specifically, lower portion 134 includes an outer surface 135 that is recessed or offset from outer edge 139 of bezel 138. Lower portion 134 also includes a radius curvature R3 (FIG. 5) along the inner surface of the lower portion to prevent chafing or fretting of conduits. The outer dimensions of lower portion 134 correspond to the inner dimensions of opening 120 of axle 112 such that the lower portion may be slidably disposed within the opening of the axle such that radius curvature R3 may at least partially align with the inner wall of the axle. As a result, radius curvature R3 provides a smooth, rounded-over surface for conduits passing through axial opening 132 of body 130 to abut against, preventing contact with the edges of opening 120 of axle, thereby preventing fretting and damage of the conduits. Flange 140 may be formed with bends, concavities, or curvatures corresponding to the convex outer surface of central tube 111 of axle 112 such that when lower portion 134 is disposed within and/or at least partially through opening 120 of the axle, the flange may be flush with the outer surface of the axle. As a result, body 130 of bulkhead 100 may be attached to axle 112 utilizing any suitable method, such as a continuous window weld (not shown) formed between outer edge 139 of bezel 138 and the outer surface of the axle, thereby preventing ingress of water, contaminants, and/or debris about the outer edge of and between the bezel and the axle. It is also contemplated that body 130 may be attached to axle 112 utilizing suitable fasteners (not shown) disposed through at least a portion of the flange and into the axle. Alternatively, body 130 may be formed such that the outer dimensions of lower portion 134 form an interference fit with opening 120 of axle 112, thereby providing attachment between the body and the axle without the use of fasteners or welds. In such a configuration, an additional gasket or seal may be placed between flange 140 and axle 112 to prevent ingress of water, contaminants, and/or debris into the axle.

Gasket 170 of bulkhead 100 may be formed from any suitable material, such as elastomer, with any suitable shape, such as circular or rectangular. In particular, gasket 170 may be formed as an annular shape that generally corresponds to and aligns with bezel 138. Gasket 170 may also be formed with a central opening 172 that aligns with opening 132 of body 130. Gasket 170 may be formed with a plurality of spaced-apart openings 173 extending through the gasket and aligning with openings 137 of bezel 138.

Bulkhead 100 also includes cover plate 180, which may be disposed over gasket 170 and within bezel 138. Alternatively, and with particular reference to FIG. 2, it is contemplated that bulkhead 100 may be utilized without cover plate 180. Cover plate 180 may be formed from any suitable material, such as metal, elastomer, or plastic, having any suitable shape, such as round or rectangular. In particular, cover plate 180 is formed with a shape corresponding to bezel 138 such that the cover plate may be seated within the bezel and on top of gasket 170. Cover plate 180 may be formed with a plurality of openings 183 formed about the periphery of and through the cover plate in a spaced-apart arrangement. More specifically, openings 183 may be formed through cover plate 180 such that the openings are aligned with openings 173 of gasket 170 and openings 137 of bezel 138. Aligned openings 183, 173, 137 of cover plate 180, gasket 170, and bezel 138, respectively, may receive a plurality of fasteners 198 to attach the cover plate to the bezel and compress the gasket. Thus, gasket 170 forms a seal between bezel 138 and cover plate 180 to prevent the ingress of water, contaminants, and/or debris into axle 112, thereby preventing potential damage to and extending the service-life of the axle.

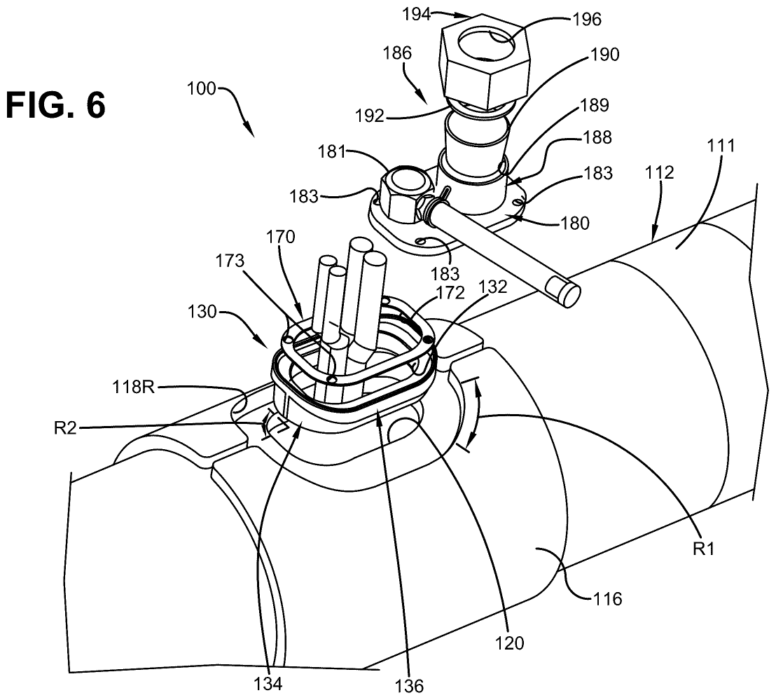

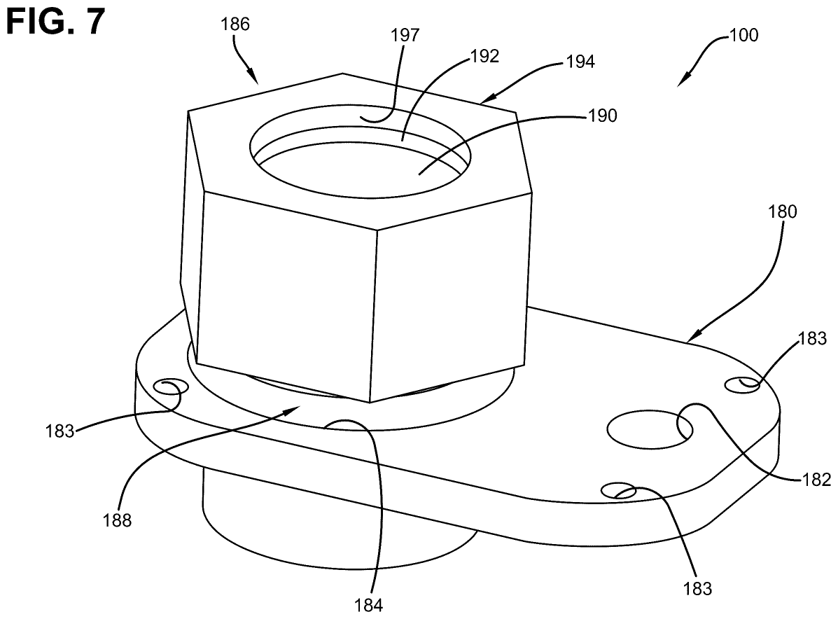

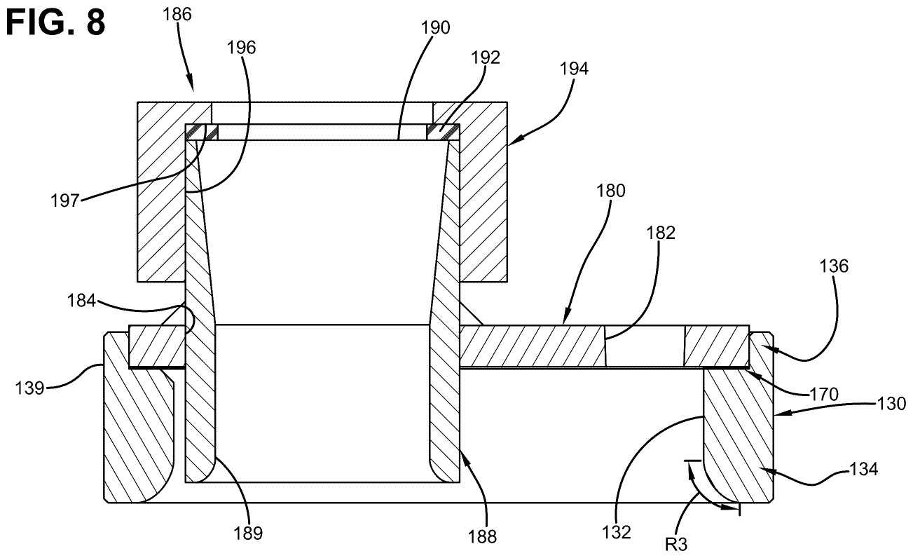

In accordance with another important aspect of the disclosed subject matter, cover plate 180 may be formed as a generally flat, uniform component, as shown in FIGS. 3-4, or may include a number of bosses (not shown) formed about the surface of the cover plate to denote locations for adding features after initial assembly and installation. In such a configuration, cover plate 180 may be advantageous for shipments of preassembled axles 112 while allowing for later custom configuration of bulkhead 100 for particular purposes. Alternatively, and with particular reference to FIGS. 6-8, cover plate 180 may be formed with one or more openings having a cumulative diameter or dimension greater than about 1.0 inch, such as fitting openings 182, 184 (FIGS. 7-8), for attaching fittings and/or passing conduits into axle 112. In particular, cover plate 180 may include fitting opening 182 for receiving an axle vent 181. Axle vent 181 may be disposed at least partially within fitting opening 182 and connected to or across cover plate 180 using any suitable means, such as a threaded connection, as is known.

Cover plate 180 may also include fitting opening 184 formed through the cover plate for receiving a compression fitting 186 adjacent axle vent 181. Compression fitting 186 includes a tubular collar 188 having a central axial opening 189 (FIGS. 6 and 8). Collar 188 may be at least partially disposed within and project outward from fitting opening 184 of cover plate 180. Collar 188 may be formed from any suitable material, such as metal, and may be attached to fitting opening 184 using any suitable means, such as a continuous weld (not shown). Opening 189 of collar 188 may be formed with a varying internal diameter or dimension such that the thickness of the walls of the collar increases along the collar from the outside of axle 112 toward the inside of the axle. Compression fitting 186 also includes a plug 190 at least partially disposed within opening 189 of collar 188. In particular, plug 190 may be formed from any suitable material, such as elastomer, with any suitable shape, such as frustoconical. More particularly, plug 190 may have a frustoconical shape having a slope that generally corresponds to and makes contact with the inner surface of collar 188 such that the plug may act as a wedge when disposed within opening 189. As a result, plug 190 aides in forming a seal to prevent water, contaminants, and/or debris from ingress into axle 112 through opening 189. Plug 190 may also be formed with a plurality of openings (not shown) through which conduits may be passed. The openings formed through plug 190 may be of any suitable size to support and/or hold conduits in slight compression, providing the conduits with strain relief, thereby reducing and/or eliminating potential damage to the conduits.

Compression fitting 186 also includes a ring 192 and cap 194 that provide compression to plug 190 within collar 188 to prevent ingress of water, contaminants, and/or debris. In particular, ring 192 may be formed from any suitable material, such as metal, and may be disposed over at least the outer portion of the top surface of plug 190. It is also contemplated that, depending upon the shape and compression of plug 190, ring 192 may also be disposed over a portion of the edge of collar 188. Cap 194 may be generally tubular having a central opening 196 and a flange 197 extending radially inward from an axial end of the central opening. Cap 194 may be disposed over ring 192, plug 190, and at least part of collar 188, interfacing with the collar such that flange 197 contacts the ring. More particularly, the inner surface of cap 194 may engage the outer surface of collar 188 using any suitable means that allow for the application of pressure on plug 190, such as a threaded connection. Ring 192 acts as an interface and provides additional sealing between cap 194 and plug 190 such that rotational movement of the cap does not cause fretting or damage to the plug. Thus, as cap 194 is tightened onto collar 188, increasing force is applied to ring 192, which applies pressure to plug 190, compressing the plug. Compression of plug 190 causes a narrowing of any openings formed through the plug such that conduits may become slightly compressed, thereby providing support as the conduits pass through the openings into axle 112.

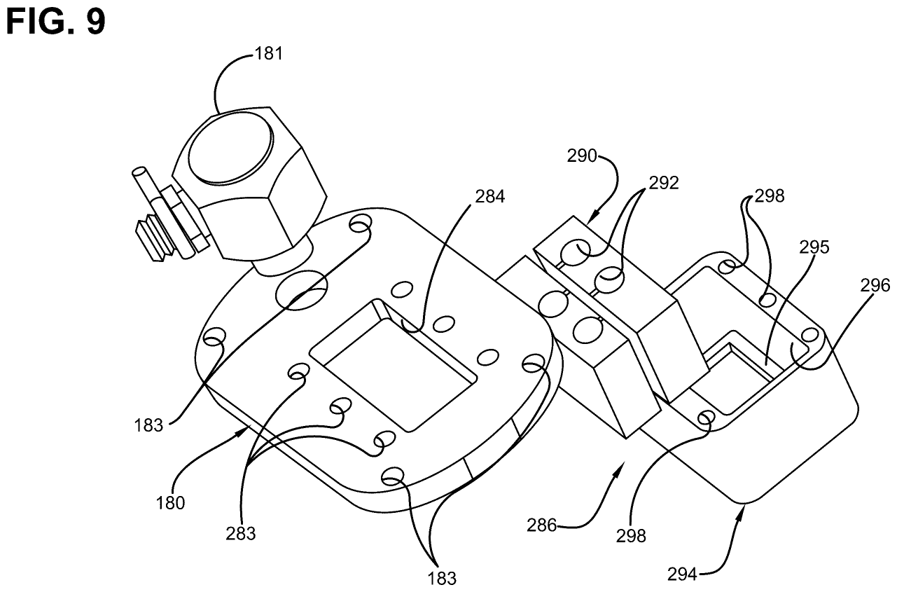

Alternatively, and with particular reference to FIGS. 9-11, it is contemplated that cover plate 180 may incorporate a removable compression fitting 286. In particular, cover plate 180 may be formed with an alternative fitting opening 284. Fitting opening 284 may be any suitable shape, such as round or rectangular. A plurality of openings 283 may be formed through cover plate 180 and spaced about the periphery of fitting opening 284 for receiving respective fasteners (not shown) to removably connect the cover plate to compression fitting 286. More particularly, compression fitting 286 may include a plug 290 and a cage 294. Plug 290 may be formed as one or more pieces from any suitable material, such as elastomer, to have a similar shape to, but larger dimensions than, fitting opening 284. One or more openings 292 of any suitable size may be formed through plug 290 to support and/or hold conduits in slight compression, providing the conduits with strain relief while also preventing ingress of water, contaminants, and debris, thereby reducing and/or eliminating potential damage to the conduits and corrosion of axle 112 and/or contamination of the wheel end assembly lubrication, thereby maintaining or extending the service-life of the axle and wheel end assembly (not shown). Cage 294 may be generally tubular with a cross-sectional shape corresponding to fitting opening 284 and an axial central opening 296. More specifically, central opening 296 may have dimensions greater than fitting opening 284 capable of receiving plug 290 such that the plug is at least partially disposed within the cage. A plurality of openings 298 may be formed into a portion of cage 294 extending in parallel with and spaced about the periphery of central opening 296. Openings 298 generally correspond to and align with openings 283 of cover plate 180 and receive respective fasteners (not shown) disposed through the aligned openings to secure cage 294 to the cover plate. Cage 294 may also be formed with a flange 295 extending radially inward from an axial end of central opening 296 opposite cover plate 180. Plug 290 may be at least partially disposed within cage 294 such that the plug is in contact with or abuts against flange 295. More specifically, because plug 290 is disposed within cage 294 and abuts flange 295, attachment of the cage to cover plate 180 causes compression of the plug such that a narrowing of openings 292 occurs, slightly compressing conduits, thereby providing support as the conduits pass through into axle 112.

Thus, first exemplary embodiment bulkhead 100, according to the disclosed subject matter, provides body 130 that is at least partially disposed within opening 120 of central tube 111 and attached to axle 112 to reinforce the axle, maintaining the strength and service-life of the axle. In addition, bulkhead 100 provides fittings 181, 186, 286 to support or connect multiple conduits passing between the interior and exterior of axle 112, allowing the conduits to be easily and efficiently routed into and through the axle. Moreover, bulkhead 100 also provides cover plate 180, gasket 170, and bezel 138 that cooperate to prevent ingress of water, contaminants, and/or debris into central tube 111 of axle 112, minimizing or preventing corrosion of the axle and/or contamination of the wheel end assembly lubrication and maintaining the strength and service-life of the axle and wheel end assembly (not shown).

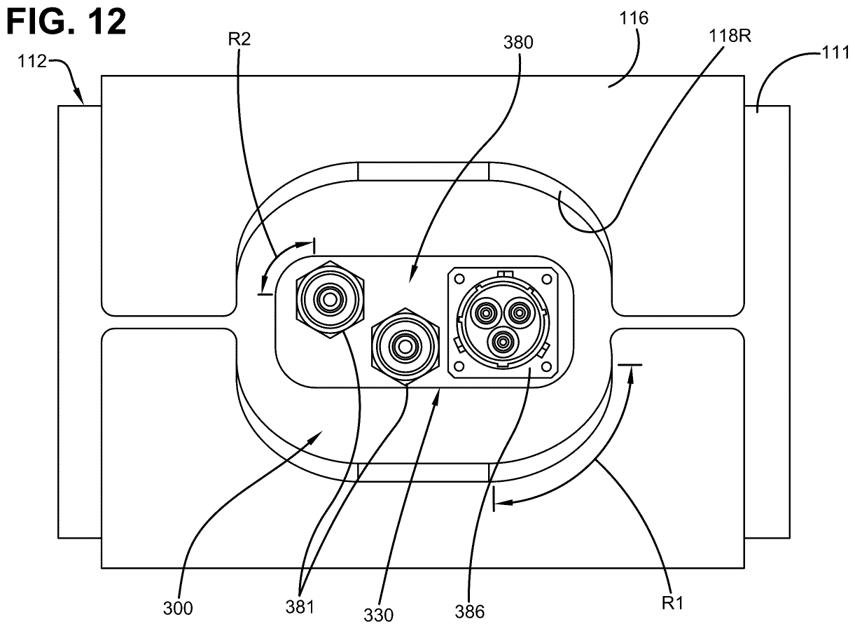

A second exemplary embodiment bulkhead 300 (FIGS. 12-15), according to the disclosed subject matter, may be incorporated into any suitable axle, such as axle 112, described above, of any suitable axle/suspension system, such as axle/suspension system 10, described above, and utilized with any suitable braking system, such as braking system 28, for a heavy-duty vehicle (not shown).

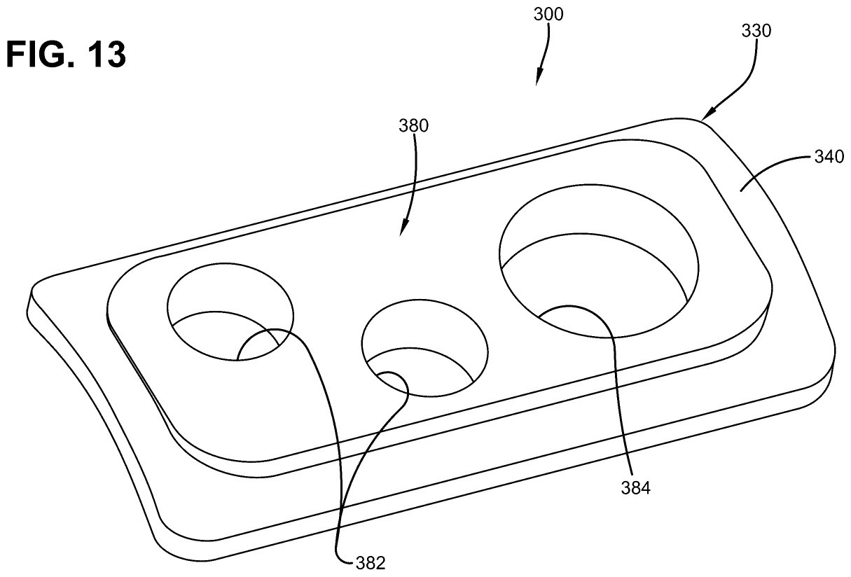

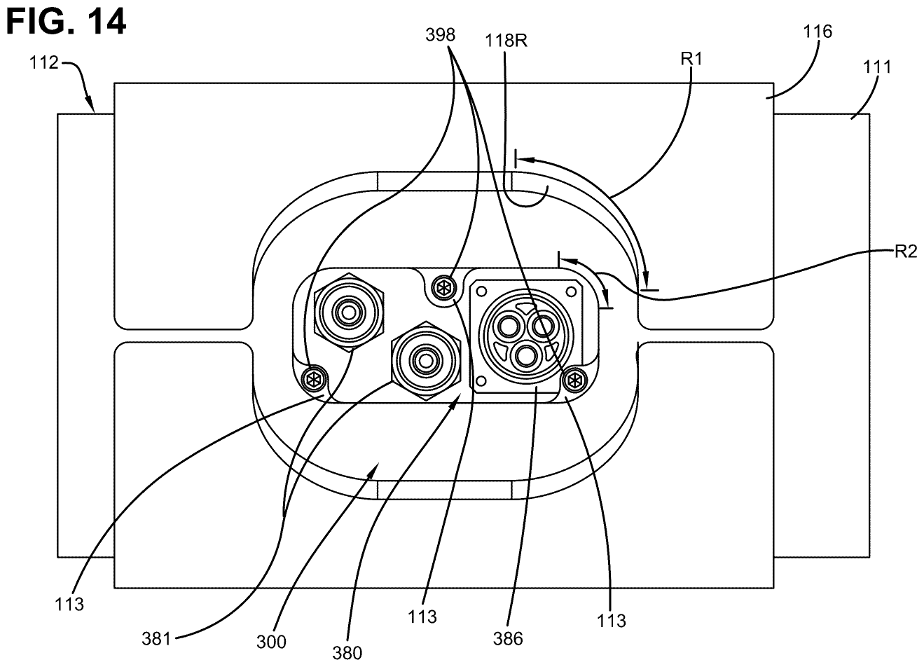

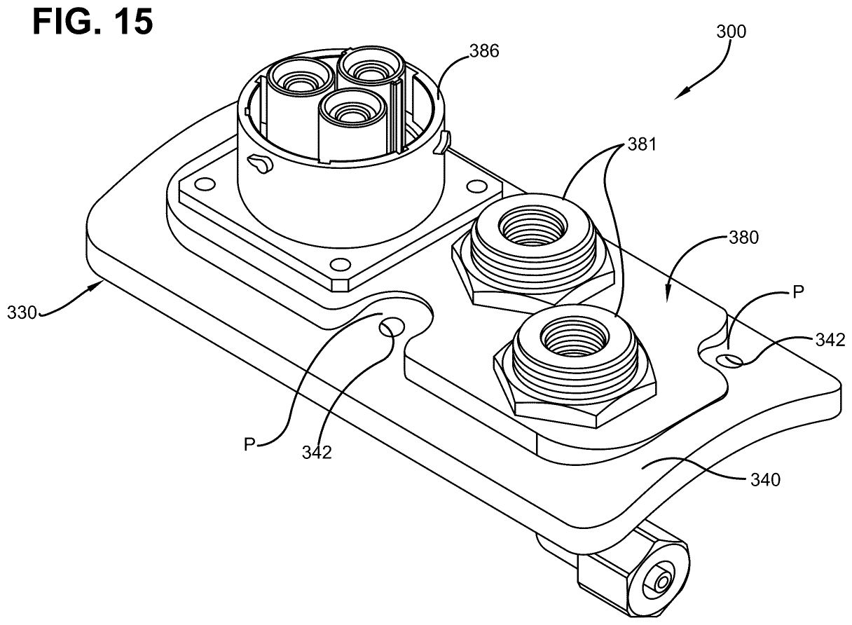

In accordance with an important aspect of the disclosed subject matter, second exemplary embodiment bulkhead 300 may be disposed within axle 112 and at least partially extend into opening 120 of the axle. In particular, bulkhead 300 includes a plate 330 having a central interface 380 surrounded by an edge 340 (FIG. 13) recessed from the interface. Plate 330 may be formed from any suitable material, such as metal, elastomer, or plastic, having any suitable shape, such as round, elliptical, polygonal, or rectangular. In particular, plate 330 may be formed with a shape corresponding to opening 120 of axle 112 but with dimensions that are greater than those of the opening. Portions of plate 330 and edge 340 may be formed with a concavity or curvature that generally corresponds to the curvature of central tube 111 of axle 112. Interface 380 may be formed as a completely planar surface with one or more openings having a cumulative diameter or dimension greater than about 1.0 inch, such as fitting openings 382, 384, extending through plate 330 for attaching fittings and/or passing conduits into axle 112. In particular, interface 380 may include fitting openings 382 for receiving respective pneumatic or electrical fittings, such as fittings 381. Each of fittings 381 may be disposed within fitting opening 382 and connected across interface 380 using any suitable means, such as a threaded connection, as is known. Interface 380 may also be formed with fitting opening 384 for receiving a fitting, such as a mil-spec fitting, bayonet-style connector, or commercially available vibration-resistant fitting 386, for passing conduits into central tube 111 of axle 112. Plate 330 may be attached to central tube 111 of axle 112 using any suitable means, such as welds. More particularly, plate 330 may be disposed within central tube 111 such that edge 340 contacts the inner surface of the central tube and interface 380 projects into and/or through opening 120. A continuous weld (not shown) may be formed between edge 340 of plate 330 and central tube 111. Alternatively, and with specific reference to FIGS. 14-15, plate 330 may be removably attached to axle 112 utilizing fasteners 398. More specifically, in such a configuration, edge 340 may be formed with one or more screw pockets P (FIG. 15) having respective openings 342. Similarly, central tube 111 may be formed with one or more tabs 113 projecting into opening 120 of axle 112 and having respective openings (not shown). The openings of tabs 113 generally correspond to and align with openings 342 of screw pockets P of edge 340 and receive respective fasteners 398 to removably attach plate 330 to the axle. It is contemplated that plate 330 may be disposed over opening 120 of central tube 111 such that edge 340 contacts the outer surface of the central tube and is attached to axle 112 by any suitable means, such as welds or fasteners 398, as discussed above. It is also contemplated that a gasket or seal (not shown) may be placed between edge 340 and the inner or outer surface of central tube 111 to prevent ingress of water, contaminants, and/or debris into the central tube of axle 112.

Thus, second exemplary embodiment bulkhead 300, according to the disclosed subject matter, provides plate 330 with interface 380 that is at least partially disposed within opening 120 of central tube 111 and attached to axle 112 to reinforce the axle, maintaining the strength and service-life of the axle. In addition, bulkhead 300 provides fittings 381, 386 to support or connect multiple conduits passing between the interior and exterior of axle 112, allowing the conduits to be easily and efficiently routed into and through the axle. Moreover, plate 330 of bulkhead 300, utilized with or without a gasket, prevents ingress of water, contaminants, and/or debris into central tube 111 of axle 112, minimizing or preventing corrosion of the axle and/or contamination of the wheel end assembly lubrication and maintaining the strength and service-life of the axle and wheel end assembly (not shown).

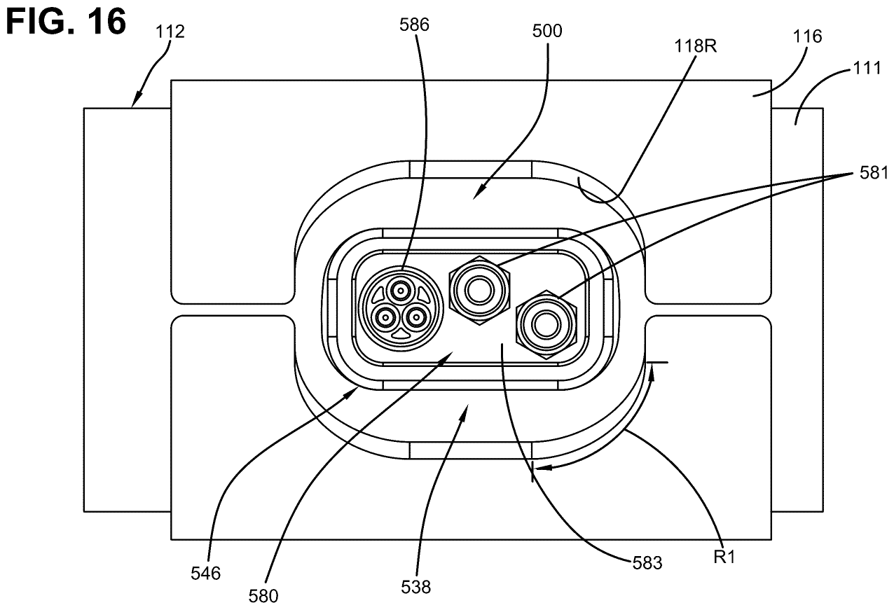

A third exemplary embodiment bulkhead 500 (FIGS. 16-18), according to the disclosed subject matter, may be incorporated into any suitable axle, such as axle 112, described above, of any suitable axle/suspension system, such as axle/suspension system 10, described above, and utilized with any suitable braking system, such as braking system 28, for a heavy-duty vehicle (not shown).

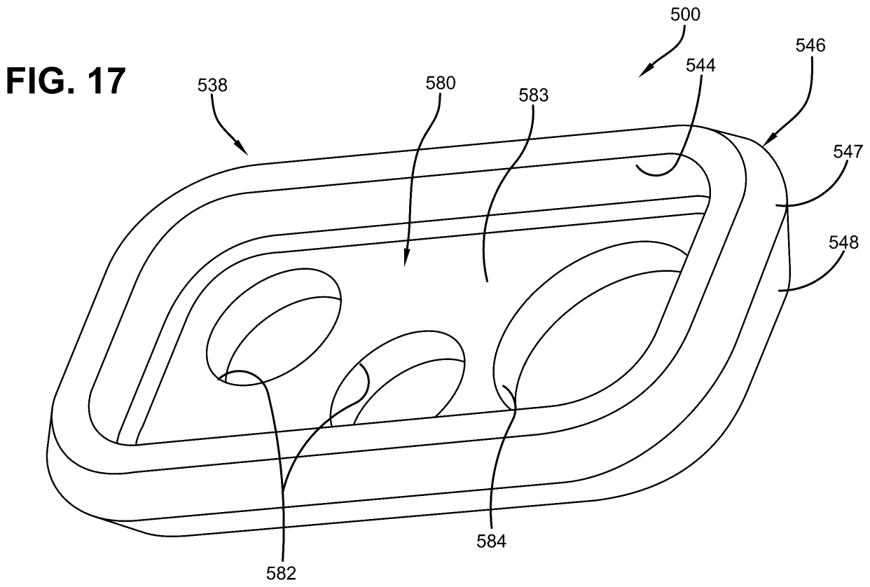

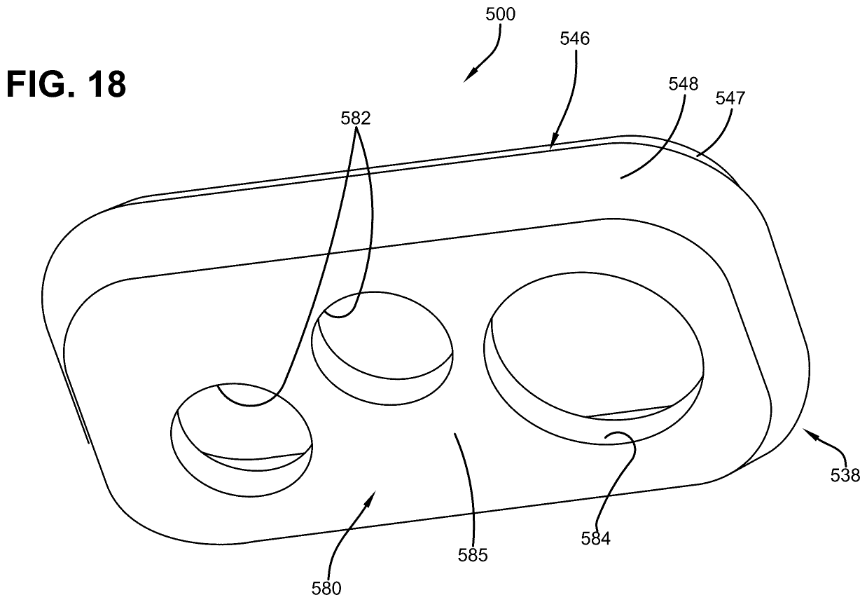

Bulkhead 500 includes an interface 580 with integrally-formed frame 538. Interface 580 and frame 538 may be formed from any suitable material, such as metal, with any suitable shape, such as rectangular or round. Interface 580 may be formed as a generally flat plate having an inner surface 583 (FIG. 16) and an outer surface 585 (FIG. 18) such that the inner surface is generally recessed within or surrounded by frame 538 while the outer surface is generally coplanar with the edge of the frame. Interface 580 may be formed with one or more openings through the interface having a cumulative diameter or dimension greater than about 1.0 inch, such as fitting openings 582, 584 (FIGS. 17-18). In particular, interface 580 may include fitting openings 582 for receiving respective pneumatic or electrical fittings, such as fittings 581. Each of fittings 581 may be disposed within fitting openings 582 and connected across interface 580 using any suitable means, such as a threaded connection, as is known. Interface 580 may also be formed with fitting opening 584 for receiving a fitting, such as commercially-available vibration-resistant fitting 586, for passing conduits into axle 112.

In accordance with an important aspect of the disclosed subject matter, frame 538 provides bulkhead 500 with integral means for externally mounting the bulkhead to axle 112. In particular, frame 538 may be formed such that at least a portion of the frame has outer dimensions at least slightly greater than the internal dimensions of opening 120. Frame 538 may be formed with an internal edge 544 that may be continuous with inner surface 583 of interface 580 and an external edge 546 that is formed about the perimeter of the frame. External edge 546 may be formed with one or more faces 547, 548 having respective slopes or angles, at least one of which may correspond to the angle of the cut forming opening 120 in central tube 111 of axle 112. More particularly, the angle of face 548 may generally correspond to or be complementary of the angle of the cut into axle 112 forming opening 120 such that the surface of the face may abut or be in contact with the cut surface of the axle. Because the outer dimensions of frame 538 are greater than the internal dimensions of opening 120, the frame, and thus bulkhead 500, cannot pass entirely through the opening. Rather, frame 538 may be sized to allow only a portion of bulkhead 500 to pass through opening 120 such that face 547 may be disposed external to axle 112. As a result, bulkhead 500 may be attached to central tube 111 of axle 112 using any suitable means, such as a continuous weld (not shown) between face 547 and the axle, preventing ingress of water, contaminants, and/or debris into the axle. It is also contemplated that bulkhead 500 may be mounted to axle 112 internally and attached using any suitable method.

Thus, third exemplary embodiment bulkhead 500, according to the disclosed subject matter, provides interface 580 that is at least partially disposed within opening 120 of central tube 111 and attached by frame 538 to axle 112 to reinforce the axle, maintaining the strength and service-life of the axle. In addition, bulkhead 500 provides fittings 581, 586 that support or connect multiple conduits passing between the interior and exterior of axle 112, allowing the conduits to be easily and efficiently routed into and through the axle. Moreover, frame 538 of bulkhead 500 also provides edge 546 having faces 547, 548 that cooperate with opening 120 of central tube 111 to prevent ingress of water, contaminants, and/or debris into the central tube of axle 112, minimizing or preventing corrosion of the axle and/or contamination of the wheel end assembly lubrication and maintaining the strength and service-life of the axle and wheel end assembly (not shown).

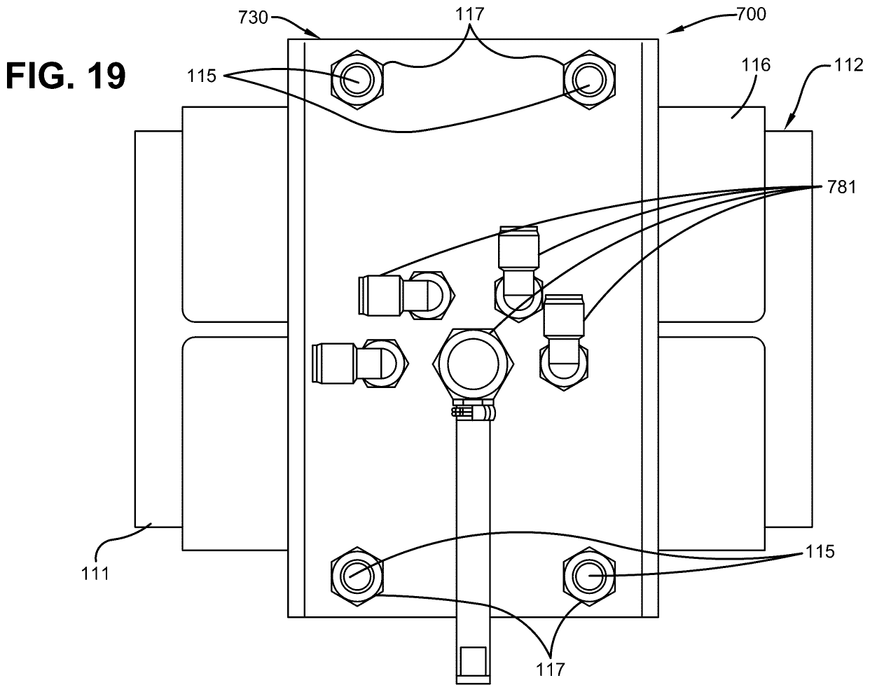

A fourth exemplary embodiment bulkhead 700 (FIGS. 19-21), according to the disclosed subject matter, may be incorporated into any suitable axle, such as axle 112, described above, of any suitable axle/suspension system, such as axle/suspension system 10, described above, and utilized with any suitable braking system, such as braking system 28, for a heavy-duty vehicle (not shown).

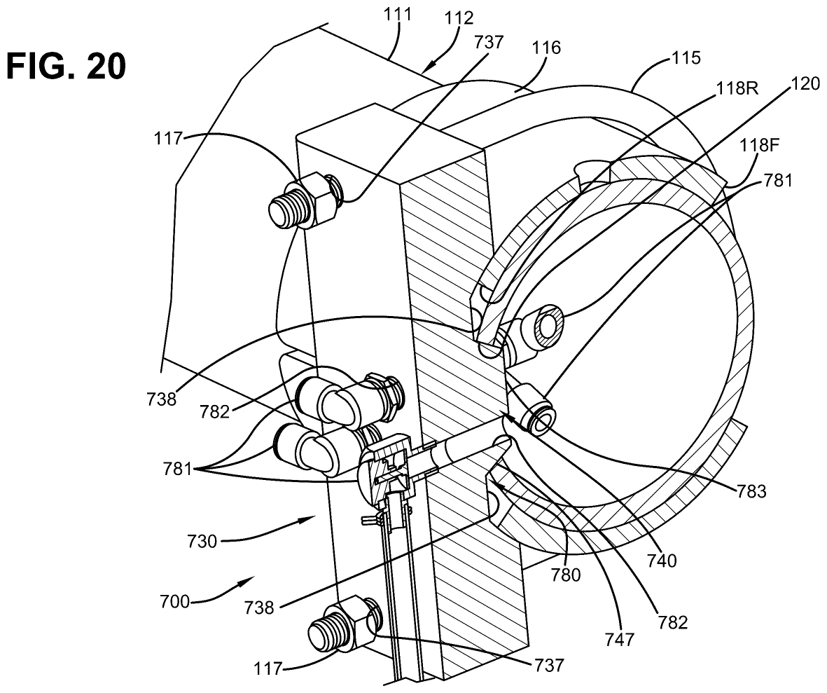

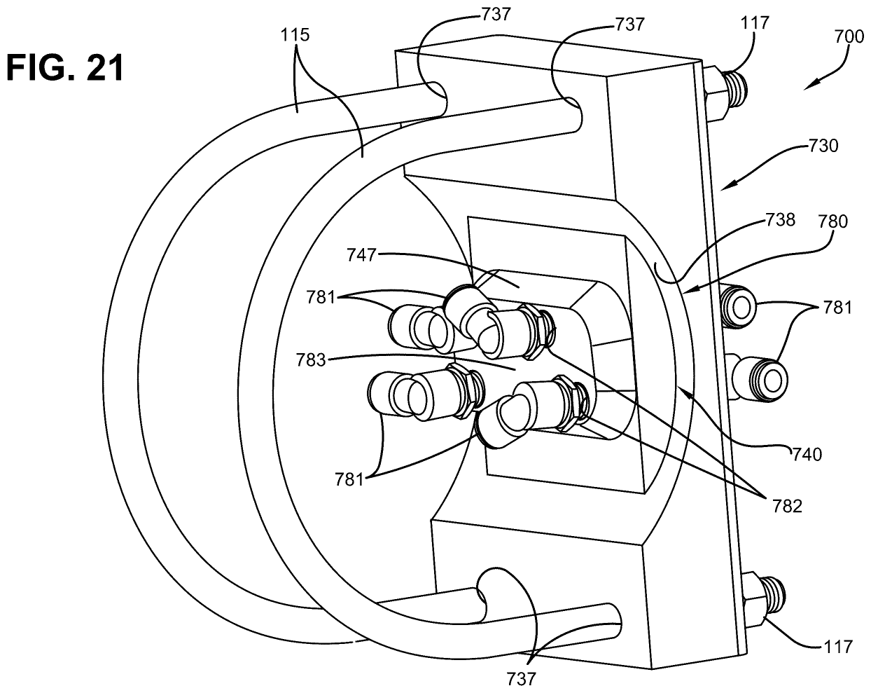

In accordance with an important aspect of the disclosed subject matter, bulkhead 700 may be disposed about and secured to central tube 111 of axle 112 and/or sleeve 116 by a pair of U-bolts 115 (FIGS. 20-21) and may at least partially extend into opening 120 of the axle. More specifically, bulkhead 700 includes a manifold 730 having a longitudinally-central interface 780. Manifold 730 may be formed from any suitable material, such as metal, elastomer, or plastic, having any suitable shape, such as superelliptical, rectangular, or the like. Manifold 730 may include respective pairs of spaced-apart openings 737 formed adjacent the longitudinal ends of and extending through the manifold for receiving respective ends of U-bolts 115. Interface 780 may be formed with a central transversely-extending semi-circular groove or recess 738 (FIG. 21) having a concavity or curvature that at least partially corresponds to the outer curvature of axle 112. Interface 780 may also be formed with a projection or protuberance 740 generally centered within recess 738 and having a planar surface 783 through which one or more openings, having a cumulative diameter or dimension greater than about 1.0 inch, such as fitting openings 782, may be formed and extend through manifold 730 for attaching fittings, such as fittings 781, and/or passing conduits into axle 112. Each of fittings 781 may be disposed within the respective ends of fitting openings 782 and connected to manifold 730, or protuberance 740, using any suitable means, such as a threaded connection, as is known. Protuberance 740 may be formed as a single or compound shape, but includes at least a portion having a shape generally corresponding to the shape of opening 120 of axle 112. More particularly, protuberance 740 may be formed with at least a portion having an edge or facet 747 having a slope or angle generally corresponding to or complementary of the slope or angle of the cut forming opening 120.

As described above, manifold 730 of bulkhead 700 may be attached to central tube 111 of axle 112 using U-bolts 115. More particularly, manifold 730 may be disposed over central tube 111 such that recess 738 of interface 780 contacts the outer surface of the central tube and such that protuberance 740 projects at least partially into and/or through opening 120, thereby allowing facet 747 to at least partially contact the cut forming the opening. It is contemplated that one or more gaskets (not shown) or seals (not shown) may be disposed between facet 747 and the cut forming opening 120 and/or between recess 738 and sleeve 116 and/or axle 112, thereby preventing ingress of water, contaminants, and/or debris. U-bolts 115 may then be disposed about axle 112 through openings 737 of manifold 730 and secured by a set of corresponding nuts 117, as is known. It is also contemplated that bulkhead 700 may be attached to axle 112 using any other suitable means, such as screws (not shown) or welds (not shown).

Thus, fourth exemplary embodiment bulkhead 700, according to the disclosed subject matter, provides manifold 730 with interface 780 that is at least partially disposed within opening 120 of central tube 111 and attached by U-bolts 115 to axle 112 to reinforce the axle, maintaining the strength and service-life of the axle. In addition, interface 780 of bulkhead 700 provides fittings 781 to connect multiple conduits passing between the interior and exterior of axle 112, allowing the conduits to be easily and efficiently routed into and through the axle. Moreover, manifold 730 of bulkhead 700, utilized with or without a gasket, prevents ingress of water, contaminants, and/or debris into central tube 111 of axle 112, minimizing or preventing corrosion of the axle and/or contamination of the wheel end assembly lubrication and maintaining the strength and service-life of the axle and wheel end assembly (not shown).

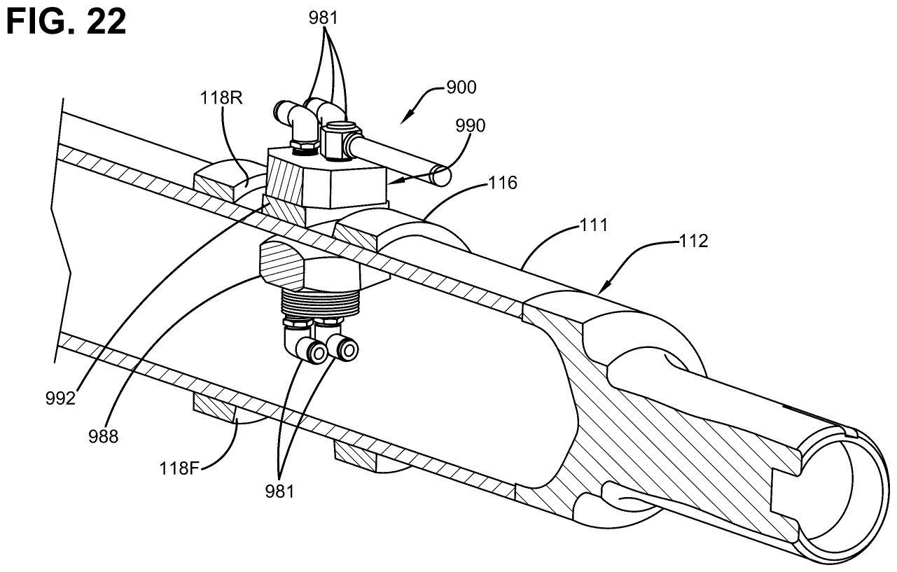

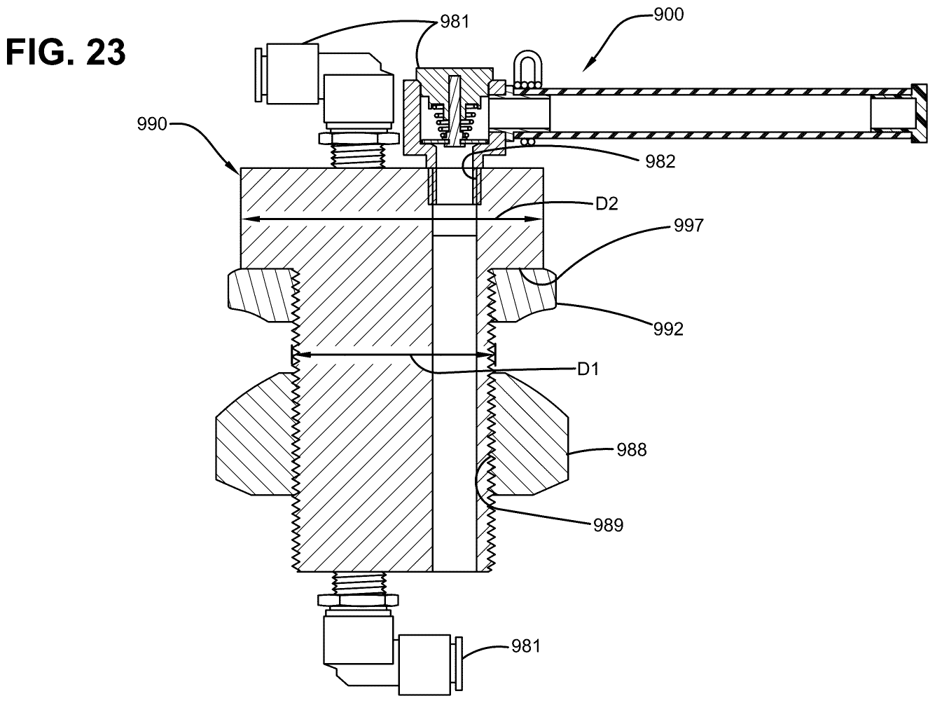

A fifth exemplary embodiment bulkhead 900 (FIGS. 22-23), according to the disclosed subject matter, may be incorporated into any suitable axle, such as axle 112, described above, of any suitable axle/suspension system, such as axle/suspension system 10, described above, and utilized with any suitable braking system, such as braking system 28, for a heavy-duty vehicle (not shown).

In accordance with an important aspect of the subject disclosure, bulkhead 900 includes a central, large or oversized threaded plug 990. In particular, plug 990 may be formed from any suitable material, such as metal or polymer, as a generally cylindrical structure having a flange 997 (FIG. 23) extending radially outward from an axial end of the plug. Plug 990 may have an outer diameter or dimension D1 that generally corresponds to the dimensions of opening 120 of axle 112. More particularly, dimension D1 may occupy a portion of window 118R in the range of from about 4% to about 70%, more preferably from about 38% to about 51%. Plug 990 may have a second outer diameter or dimension D2 taken about the axial end of the plug with flange 997 that may be generally greater than dimension D1. One or more openings having a cumulative diameter or dimension greater than about 1.0 inch, such as fitting openings 982 (FIG. 23), may be formed and extend axially through plug 990. Fitting openings 982 may receive any suitable fittings, such as fittings 981, at either axial end of plug 990 or may be utilized to pass conduits through the plug.

Bulkhead 900 also includes an annular gasket or O-ring 992 and a nut 988. O-ring 992 may be disposed about plug 990 adjacent to and contacting flange 997. Nut 988 may be formed with a central opening 989, as is known. Nut 988 may be affixed to either the inner surface or the outer surface of central tube 111 of axle 112 using any suitable method, such as welding, such that central opening 989 of the nut is aligned with opening 120 of the axle. Plug 990 may be received through the aligned openings 120, 989 of axle 112 and nut 988, respectively, from the interior or exterior of central tube 111 and threadably engage with the nut, securing the plug to the axle and compressing O-ring 992, thereby preventing ingress of water, contaminants, and/or debris into the axle. It is also contemplated that nut 988 may not be affixed to central tube 111. In such configuration, plug 990 may be disposed at least partially through opening 120 of axle 112 from the interior or exterior of the axle before nut 988 is disposed over and threadably engages the plug to secure the plug to the axle and compress O-ring 992, thereby preventing ingress of water, contaminants, and/or debris into the axle.

Thus, fifth exemplary embodiment bulkhead 900, according to the disclosed subject matter, plug 990 that is disposed through opening 120 of central tube 111 and attached by nut 988 to axle 112 to reinforce the axle, maintaining the strength and service-life of the axle. In addition, plug 990 includes fittings 981 to connect multiple conduits passing between the interior and exterior of axle 112 allowing the conduits to be easily and efficiently routed into and through the axle. Moreover, bulkhead 900 also provides O-ring 992, which prevents ingress of water, contaminants, and/or debris into central tube 111 of axle 112, minimizing or preventing corrosion of the axle and/or contamination of the wheel end assembly lubrication and maintaining the strength and service-life of the axle and wheel end assembly (not shown).

It is contemplated that bulkheads 100, 300, 500, 700, 900, according to the disclosed subject matter, could be utilized with all types of axles, including thick-walled axles and those types of axles other than shown and described above, including axles incorporated into any suitable beam-type axle/suspension system, such as underslung, overslung, or through-the-wall, without affecting the overall concept or operation. It is also contemplated that bulkheads 100, 300, 500, 700, 900 could be used with other types of reinforcing structures than those shown and described without affecting the overall concept or operation. Moreover, bulkheads 100, 300, 500, 700, 900 could be formed with different cross-sectional shapes and/or sizes and/or may be installed and/or attached at other suitable relative positions along axle 112, such as openings formed within front windows 118F (FIGS. 20, 22) of sleeve 116, without affecting the overall concept or operation of the disclosed subject matter.

Accordingly, bulkheads 100, 300, 500, 700, 900, according to the disclosed subject matter, are simplified; provide an effective, safe, inexpensive, and efficient structure and method, which achieve all the enumerated objectives; provide for eliminating difficulties encountered with prior art axles; and solve problems and obtain new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed. Moreover, the description and illustration of the disclosed subject matter is by way of example, and the scope of the disclosed subject matter is not limited to the exact details shown or described.

Having now described the features, discoveries, and principles of the invention; the manner in which the bulkheads are used and installed; the characteristics of the construction, arrangement and method steps; and the advantageous, new and useful results obtained, the new and useful structures, devices, elements, arrangements, process, parts, and combinations are set forth in the appended claims.

What is claimed is:

1. An axle for a heavy-duty vehicle, said axle comprising:
a central tube;
a pair of spindles, each spindle being disposed at a respective axial end of said central tube; and
a bulkhead disposed at least partially over an opening formed into the central tube and attached to said axle;
wherein said bulkhead provides connection for conduits passing from outside of the axle into the central tube.

2. The axle for heavy-duty vehicles of claim 1, said bulkhead further comprising a tubular body having upper and lower portions and a central opening formed through said upper and lower portions of said body.

3. The axle for heavy-duty vehicles of claim 2, said upper portion of said body of said bulkhead further comprising a bezel having an outer edge extending radially outward from said central opening to form a flange;
said bezel being recessed;
said flange having a curvature corresponding to the outer surface of said axle for contacting and attachment to the axle when the bulkhead is disposed at least partially within the opening of the axle.

4. The axle for heavy-duty vehicles of claim 3, said bulkhead further comprising an annular gasket disposed over said bezel and a plate, said plate being disposed over said gasket and removably attached to said body of the bulkhead to prevent ingress of water, contaminants, and debris into said central tube.

5. The axle for heavy-duty vehicles of claim 4, said plate further comprising a plurality of bosses.

6. The axle for heavy-duty vehicles of claim 4, said plate further comprising an interface with at least one opening formed through the plate and having a cumulative diameter greater than about 1.0 inch.

7. The axle for heavy-duty vehicles of claim 6, said bulkhead further comprising at least one fitting attached to said plate through said at least one opening to provide connection for conduits passing from outside of the axle into the central tube.

8. The axle for heavy-duty vehicles of claim 7, said at least one fitting being a compression fitting that provides support for conduits passing from outside of said axle into said central tube.

9. The axle for heavy-duty vehicles of claim 1, said bulkhead further comprising a plate having a curvature corresponding to the curvature of said axle;
said plate including a planar interface surrounded by an edge recessed from said interface.

10. The axle for heavy-duty vehicles of claim 9, said interface further comprising at least one opening with a cumulative diameter greater than about 1.0 inch.

11. The axle for heavy-duty vehicles of claim 10, said bulkhead further comprising at least one fitting attached to said plate through said at least one opening to provide connection for conduits passing from outside of the axle into the central tube.

12. The axle for heavy-duty vehicles of claim 11, said at least one fitting being a compression fitting that provides support for conduits passing from outside of said axle into said central tube.

13. The axle for heavy-duty vehicles of claim 11, said plate being disposed within and attached to said central tube of said axle to prevent ingress of water, contaminants, and debris into the central tube;
wherein said interface is at least partially disposed within said opening of the axle; and
said recessed edge is in contact with the inner surface of the central tube.

14. The axle for heavy-duty vehicles of claim 11, said recessed edge further comprising at least one screw pocket, said at least one screw pocket including an opening formed through said plate; and
said axle being formed with at least one tab, said at least one tab including an opening formed through the tab.

15. The axle for heavy-duty vehicles of claim 14, said plate being disposed within said central tube of said axle;
said interface being at least partially disposed within said opening of the axle;
said recessed edge being in contact with the inner surface of said central tube; and
said opening of said screw pocket and said opening of said tab are aligned for receiving a fastener to removably attach the plate to the axle.

16. The axle for heavy-duty vehicles of claim 1, said bulkhead further comprising a planar interface having an inner surface recessed within and integrally formed with and surrounded by a frame;
said frame having at least a portion with an outer dimension that is greater than said opening of said central tube.

17. The axle for heavy-duty vehicles of claim 16, said frame further comprising an external edge having at least one face;
said at least one face being formed with a slope corresponding to the slope of the cut forming said opening of said central tube of said axle.

18. The axle for heavy-duty vehicles of claim 17, said bulkhead being at least partially disposed within and attached about said opening of said central tube to prevent ingress of water, contaminants, and debris into the central tube;
wherein said face of said external edge of said frame abuts the surface of said cut forming the opening.

19. The axle for heavy-duty vehicles of claim 18, said interface further comprising at least one opening with a cumulative diameter greater than about 1.0 inch.

20. The axle for heavy-duty vehicles of claim 19, said bulkhead further comprising at least one fitting attached to said interface through said at least one opening to provide connection for conduits passing from outside of the axle into the central tube.

21. The axle for heavy-duty vehicles of claim 20, said at least one fitting being a compression fitting that provides support for conduits passing from outside of said axle into said central tube.

22. The axle for heavy-duty vehicles of claim 1, said bulkhead further comprising a manifold with a central interface having a semi-circular recess that corresponds to the outer surface of said central tube.

23. The axle for heavy-duty vehicles of claim 22, said interface further comprising a projection centered within said recess, at least a portion of said projection having a facet with a slope corresponding to the slope of the cut forming said opening of said central tube.

24. The axle for heavy-duty vehicles of claim 23, said interface further comprising a planar surface with having at least one opening with a cumulative diameter greater than about 1.0 inch formed through said manifold.

25. The axle for heavy-duty vehicles of claim 24, said interface further comprising at least one fitting connected to said manifold through said at least one opening to provide connection for conduits passing from outside of the axle into the central tube.

26. The axle for heavy-duty vehicles of claim 25, said at least one fitting being a compression fitting that provides support for conduits passing from outside of said axle into said central tube.

27. The axle for heavy-duty vehicles of claim 25, said bulkhead further comprising at least one pair of openings formed through the bulkhead, each one of said at least one pair of openings being adjacent an opposite longitudinal end of the bulkhead;
the bulkhead being disposed over said opening of said central tube;
said recess contacting the outer surface of the central tube; and
the at least one pair of openings receiving a U-bolt to removably connect the bulkhead to said axle.

28. The axle for heavy-duty vehicles of claim 27, said projection of said interface being at least partially disposed within said opening of said central tube;
said facet of said portion of the projection abutting the surface of said cut forming the opening of the central tube.

29. The axle for heavy-duty vehicles of claim 27, said bulkhead further comprising a gasket interposed between said facet and said opening of said central tube of said axle to prevent ingress of water, contaminants, and debris into the central tube.

30. The axle for heavy-duty vehicles of claim 1, said bulkhead further comprising an oversized plug having a threaded portion with a first outer dimension corresponding to the inner dimension of said opening of said central tube;
and a non-threaded portion adjacent an axial end of said plug with a second outer dimension that is greater than the first outer dimension.

31. The axle for heavy-duty vehicles of claim 29, said first outer dimension occupying a portion of said opening of said central tube in the range of from about 4% to about 70%.

32. The axle for heavy-duty vehicles of claim 29, said first outer dimension occupying a portion of said opening of said central tube in the range of from about 38% to about 51%.

33. The axle for heavy-duty vehicles of claim 29, said plug further comprising at least one opening with a cumulative diameter greater than about 1.0 inch formed axially through the plug.

34. The axle for heavy-duty vehicles of claim 32, said bulkhead further comprising at least one fitting attached to said plug through said at least one opening to provide connection for conduits passing from outside of the axle into the central tube.

35. The axle for heavy-duty vehicles of claim 33, said at least one fitting being a compression fitting that provides support for conduits passing from outside of said axle into said central tube.

36. The axle for heavy-duty vehicles of claim 33, said bulkhead further comprising an O-ring disposed about said threaded portion of said plug.

37. The axle for heavy-duty vehicles of claim 35, said bulkhead further comprising a nut affixed to one of the inner or outer surface about said opening of said central tube of said axle;
said nut having a central opening that is aligned with the opening of the central tube.

38. The axle for heavy-duty vehicles of claim 36, said plug being at least partially disposed within said opening of said central tube and threadably engaging said nut to removably connect said bulkhead to the central tube of said axle to prevent ingress of water, contaminants, and debris into the central tube.
